(19) United States
(12) Patent Application Publication
(10) Pub. No.: US 2012/0296781 A1
(43) Pub. Date: Nov. 22, 2012

(54) Compartmentalized Delivery and Removal Container System for Construction Materials

(75) Inventors: Brook Arthur Edwards, Tipton, IN (US); Linda Sue Edwards, Tipton, IN (US)

(73) Assignee: RECYCLEGUY, INC., Tipton, IN (US)

(21) Appl. No.: 13/108,068

(22) Filed: May 16, 2011

(51) Int. Cl. G06Q 10/00; B65D 6/28

(52) U.S. Cl. 705/28; 220/4.01

(57) ABSTRACT

A roll-on, roll-off compartmentalized container developed for the construction industry and the method of utilizing the container. The present invention is concerned with a compartmentalized roll-off container for use on construction sites, especially for roofing projects, and designed to be delivered by a transport truck equipped to transport the container, such as a hoist truck, and roll the container off of the truck onto the ground. Additionally, the container includes various compartments to allow for delivery of new construction materials in certain compartments and removal of waste material and material to be recycled in the same or other compartments.

### BACKGOUND OF THE INVENTION

The present invention relates to the field of containers used for delivery and removal of materials from a construction site. More specifically, the present invention is a roll-on, roll-off container (or roll-off container) developed for the roofing industry and the method of utilizing the container. The present invention is concerned with a compartmentalized roll-off container for use on construction sites and designed to be delivered by a transport truck equipped to transport the container - such as a hoist truck, a hook lift truck or a cable lift truck - and roll the container off of the truck onto the ground. Additionally, the container includes various compartments to allow for delivery of new construction materials in certain compartments and removal of waste material and material to be recycled in the same or other compartments.

Roll-off and other containers of many sizes and types are known and are often used in the collection and transportation of numerous materials including waste materials; residential, commercial and industrial refuse or debris; bulk materials; finished products; parts; or components. Generally, a container is transported by a transport truck to the site where it is to be filled. The container is unloaded from the transport truck in some cases by tilting the bed and setting the container on the ground with the aid of a container retrieving hoist mechanism. The container is then filled while sitting on the ground, floor, or other surface before being reloaded onto the transport truck and transported elsewhere to be emptied or the like.

A number of typical containers used as roll-off or other shipping containers are described by the following U.S. Patents.

U.S. Pat. No. 7,318,611 relates to a roll-off container with an adjustable attachment apparatus and designed to be used with a hoist truck.

U.S. Pat. No. 7,441,671 relates to a shipping container with auxiliary door for bulk cargo. The auxiliary door comprises a plurality of separately moveable portions moveable between open and closed positions.

U.S. Pat. No. 6,364,148 relates to a storage pod for underground mining machines with compartments for supplying consumable materials for use in the mining operation.

U.S. Pat. No. 6,814,396 relates to a compartmentalized dump body for a dump truck. The dump body includes a containment base having a bottom and a plurality of sides. A side door is installed on the dump body to allow a transportation vehicle to carry both packaged and loose loads. The side door permits the loading and unloading of pallets or other packaged loads with a forklift onto the dump body, while the dump body remains tippable for unloading loose loads.

Prior art containers have been designed with standardized open compartments for the sole purpose of collecting waste material on the job site. At construction sites, roll-off containers are typically delivered to a job empty for the purpose of providing a place to dispose of waste materials for later removal. Once the job is completed or the container is full of waste materials, a transport truck arrives on-site, hooks up to the container and rolls it onto the truck for removal from the site.

Separately, new construction materials are typically delivered by a different delivery truck. For example, a truck delivering shingles on-site may weigh 56,000 lbs and may include a portable fork lift attached to the rear of the truck for use in unloading the supplies. These vehicles can cause damage when maneuvering in residential areas, driveways or construction sites and may have difficulty delivering materials to an optimal location for access by construction workers. Further, these trucks and forklifts are expensive to own, operate and insure.

Another problem with delivering construction materials, such as roofing shingles, to a job site where the materials are staged outdoors is that they are exposed to the weather. Exposure to excessive sunlight, rain, snow or ice can contribute to degradation of the construction materials and may also make the materials difficult to handle by construction workers. For example, shingles stored in freezing weather are not very pliable and may further be covered in snow or ice. Additionally, open storage of materials on construction sites is not secure and adds the risk of theft or other vandalism.

The prior art fails to solve the problem of efficiently delivering construction materials to the point of use on a construction site and also providing an efficient means of removing waste and recyclable materials from the site. Also lacking is the additional feature of providing secure storage of new materials out of the exposure of the weather.

### BRIEF SUMMARY OF THE INVENTION

According to the present invention there is provided a compartmentalized container for delivery to a construction site where one or more compartments are provided for delivering new construction materials to the site, providing secure storage of the new materials until time of use, providing one or more compartments for disposing of waste or recyclable materials from the construction site, and providing for ease of removal from the construction site at the completion of the project.

This invention relates to a compartmentalized container (dumpster) designed for use on construction sites. The various compartments allow the container to be delivered to the construction site with building materials pre-stocked in certain compartments. For instance, a roofing contractor would be able to have the roofing shingles and associated installation materials delivered in a separate compartment of the same container into which the waste and recycled materials will be placed for removal. The various compartments can also be utilized for returning overages of supplies to the distributor for credit against a particular job.

The present invention provides a novel method of managing the delivery and removal of materials from a construction site that is efficient in delivery methods, in utilization of space at the construction site and in quality of storage of new materials prior to use. Additionally, the prior patents and commercial techniques do not suggest the present inventive combination of component elements arranged, configured and utilized in the method as disclosed herein.

The present invention provides for delivering new materials by loading them through doors on one or more sides of the container. This allows the container and new materials to be delivered to the job site at one time. The on-site workers then unload the new supplies as they are needed while remaining supplies are kept safe and dry. This also eliminates the need to take up additional space on the construction site, such as additional space in a homeowner's driveway that may otherwise be utilized as parking space. In many cases, this may help avoid the need to park in the street, which may not be allowed by the restrictions of a home owners' association.

Another feature of this invention is to provide a means of heating or cooling new construction materials, such as shingles, that are stored within the compartmentalized container. One or more ports are provided through which heated or cooled air is injected. The heating of materials may be accomplished by blowing in heated air using an external heater, such as an electric or kerosene heater and connected by flexible tubing or other means of channeling the heated air through a port to the closed compartment where new materials are stored. This feature will, for example, warm shingles to make them pliable in order to facilitate roofing work in cold weather. Likewise, cool air can be blown in to help keep materials such as roofing shingles from getting too hot or sticking together on hot days.

The present invention achieves its intended purposes, objects, and advantages through a new, useful and unobvious combination of component elements and methods, with the use of a minimum number of functioning parts, at a reasonable cost to manufacture, and by employing only readily available materials.

In order that the detailed description of the invention may be better understood and that the present contribution to the art can be more fully appreciated, additional features of the invention will be described hereinafter. It should be appreciated by those skilled in the art that the conception and the disclosed specific methods and structures may be readily utilized as a basis for modifying or designing other structures for carrying out the same purposes of the present invention. It should be realized by those skilled in the art that such equivalent methods and structures do not depart from the spirit and scope of the invention.

For a better understanding of the invention, its operating advantages and the specific objects attained by its uses, reference should be made to the accompanying drawings and descriptive matter in which there are illustrated preferred embodiments of the invention. The foregoing has outlined some of the more pertinent objects of the invention. These objects should be construed to be merely illustrative of some of the more prominent features and applications of the present invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiments in addition to the scope of the invention illustrated by the accompanying drawings.

### BRIEF DESCRIPTION OF THE DRAWINGS

The foregoing and other objects, features and advantages of the invention will become more fully understood from the following description of the preferred embodiments of the invention as illustrated in the accompanying drawings in which like reference characters refer to the same parts throughout different views. The drawings are not necessarily to scale, emphasis instead being placed upon illustrating the principles of the invention.

FIG. 1 is a perspective view of a compartmentalized container in accordance with the present version of the invention.

FIG. 2 is an elevation view of the side of a compartmentalized container in accordance with the present version of the invention.

FIG. 3 is a perspective view of a compartmentalized container in accordance with the present version of the invention showing the front side doors in an open position and a ramp positioned at one door opening.

FIG. 4 is an elevation view of the side of a compartmentalized container in accordance with the present version of the invention showing the front side doors in an open position.

FIG. 5 is a perspective view of an alternate configuration of the compartments within the compartmentalized container in accordance with the present version of the invention.

FIG. 6 is a perspective view of an alternate configuration of the compartments within the compartmentalized container in accordance with the present version of the invention where the front side door is shown in an open position.

FIG. 7 is a perspective view of an alternate configuration of the compartments within the compartmentalized container showing a single internal compartment in accordance with the present version of the invention where the front side doors are shown in an open position.

FIG. 8 is an elevation view of an alternate configuration of the compartments within the compartmentalized container showing a single internal compartment in accordance with the present version of the invention where the front side doors are shown in an open position.

FIG. 9 is a perspective view showing the compartmentalized container with a hinged top cover for protecting material within the container from weather and theft of material on the job site.

FIG. 10 is an elevation view showing the compartmentalized container with a hinged top cover.

FIG. 11 shows a detailed illustration of the hinged top cover with ports.

FIG. 12 shows a compartmentalized container and hook lift truck used for delivery of the container.

FIG. 13 shows a flow diagram of the process of using the compartmentalized container for material management at a construction site.

### DRAWING REFERENCE NUMERALS

The following table lists the drawing reference numerals with a brief description of each identifying numeral.

| | |
|---|---|
| 10 | Compartmentalized container |
| 12 | Front wall of container |
| 14 | Back door of container |
| 15 | Side walls of container |
| 16 | Bottom plate of container |
| 20 | Front compartment of container |
| 30 | Rear compartment of container |
| 40 | Roller |
| 50 | Front side-door of container |
| 60 | Front top split side-door of container |
| 62 | Door top locking tabs |
| 64 | Wall top locking tabs |
| 65 | Front left side-door of container, front hinge |
| 70 | Front bottom split side-door of container |
| 75 | Ramp |
| 80 | Divider wall main section |
| 81 | Divider wall base section |
| 90 | Hinged removable top cover |
| 92 | Top cover hinge |
| 93 | Top cover hinge pin |
| 94 | Top cover handle |
| 95 | Cover locking tabs |
| 96 | Vent port |
| 97 | Vent port cover |
| 98 | Locking pin |
| 99 | Conditioned air injection tube |
| 100 | Hook lift attachment assembly |
| 110 | Hook lift bar |
| 115 | Rear compartment, alternate configuration |
| 120 | Front compartment, alternate configuration |
| 200 | Hook lift transport truck |
| 220 | Hook lift mechanism |
| 240 | Truck bed roller |

### DETAILED DESCRIPTION OF THE INVENTION

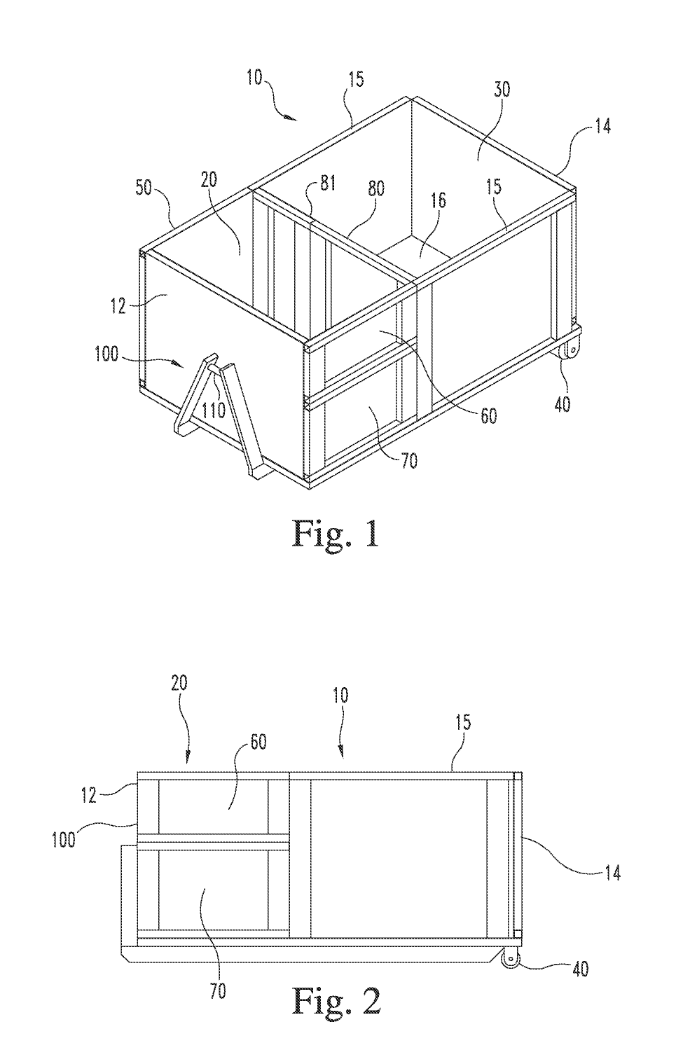

Referring now to the drawings and, in particular, to FIG. 1 and FIG. 2 wherein there are illustrated a first embodiment of the compartmentalized container 10, a detailed description of the invention is provided herein.

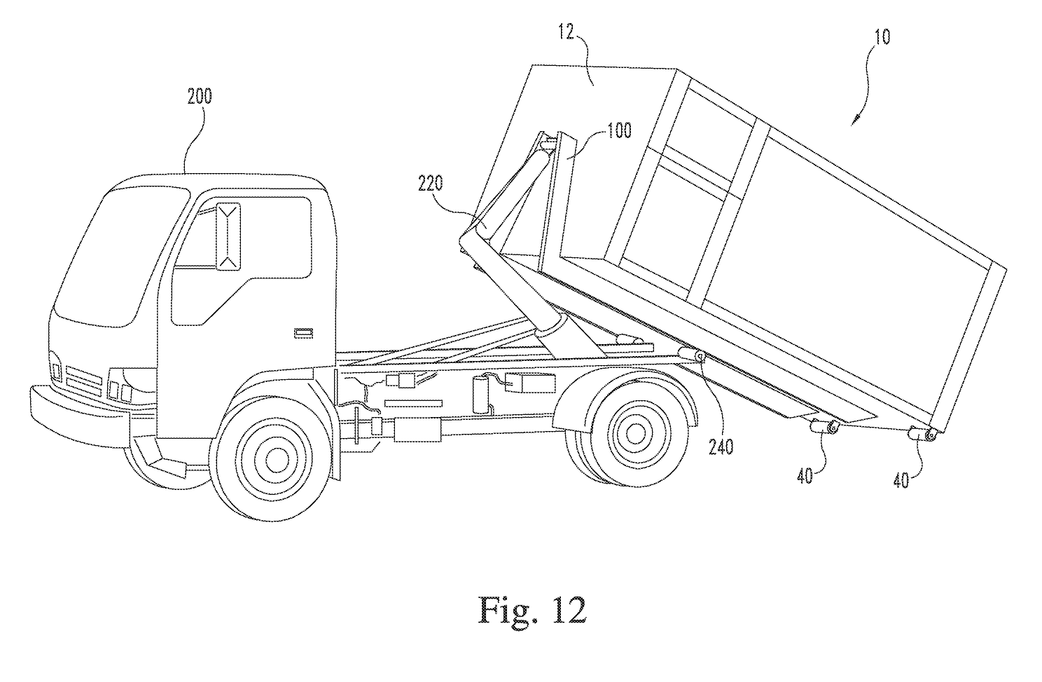

In one embodiment, the compartmentalized container 10 is shown with a front wall 12, a back door 14, side walls 15, and a bottom plate 16. The container 10 has bottom rollers 40 for facilitating roll-on and roll-off of a hook lift transport truck 200, shown in FIG. 12. The front wall 12 has an integrated hook lift attachment assembly 100 that includes a hook lift bar 110. The container 10 is rolled off onto a staging surface, such as a driveway, parking lot or ground at the construction site. The bottom plate 16 may typically be elevated above the staging surface by several inches if, for example, wooden blocks or other spacers are positioned under the container 10 to prevent damaging the staging surface.

In FIG. 1, the container is shown with a front compartment 20 and a rear compartment 30 separated by a hinged divider wall consisting of a divider wall main section 80 and a divider wall base section 81. The front compartment 20 is accessible from the outside of the container 10 by front side-door 50 and by front top split side-door 60 and front bottom split side-door 70.

Each the back door 14, the front side door 50, the front top split side-door 60 and the front bottom split side-door 70 are hinged so that they can be opened for accessing the various inner compartments of the container 10. The internal divider wall base section 81 is rotationally attached, such as by a hinge, to the side wall 15 of the container 10 but is able to be locked in place in the position as shown in FIG. 1 and FIG. 2. The divider wall main section 80 is connected rotationally, such as by a hinge, to the divider wall base section 81 and extends across the container 10 to the opposite side wall 15.

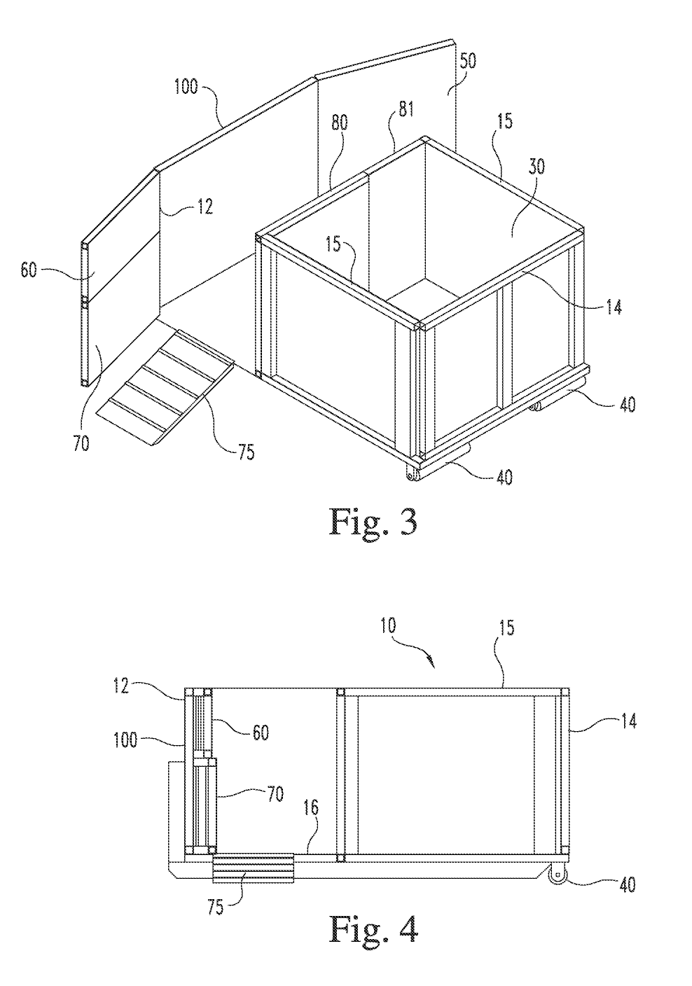

Referring now to FIG. 3 and FIG. 4, the compartmentalized container 10 is shown with front side-door 50, front top split side-door 60 and front bottom split side-door 70 in open positions with the doors hinged to the front. FIG. 3 illustrates the external access to the front compartment 20 provided by the side doors for purposes of loading and unloading materials. A ramp 75 is provided to allow ease of access from ground elevation to the floor 16 of the container 10. A ramp 75 can be provided for any of the doors to the container 10, including the back door 14, the front side door 50, and the location of the front top split side-door 60 and the front bottom split side-door 70.

One benefit of the split side doors 60 and 70 is that when the front compartment is used for collection of discarded waste or recycled material, the bottom split side door 70 can be closed while the top split side door 60 is open in order to provide easier access for a construction worker standing on the ground to place waste into the container 10 without the need to lift the waste over the full height of the container 10, such as the full height of the side wall 15, until such time that the front compartment 20 has been filled to the height of the bottom split side door 70. Likewise, the side door 50 or the set of split side doors 60 and 70 can be opened and the ramp 75 put in place so that a construction worker can walk up the ramp into the container 10 to place waste material or alternately may use a wheelbarrow rolled into the container 10 up the ramp 75 to discard a wheelbarrow full of waste.

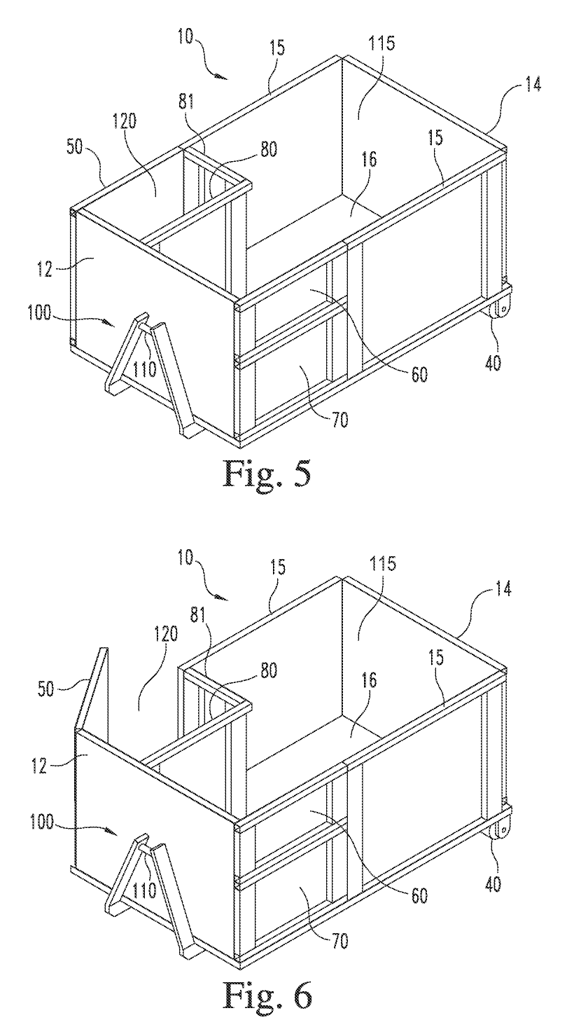

Another configuration of the compartmentalized container 10 is shown in FIG. 5 and FIG. 6 where the internal divider wall main section 80 is configured such that it is hinged forward such that the distal rotating end connects to the inside of front wall 12 to form an alternate configuration of interior compartments as alternate rear compartment 115 and alternate front compartment 120. Such reconfiguration allows the size of compartments to be optimized for the amount of new material being delivered to the site within the container 10. This also allows new construction material to be delivered in larger front compartment 20 as shown in FIG. 1, and as the new material is depleted, the container 10 can be reconfigured as in FIG. 5 and FIG. 6. In the configuration shown in FIG. 5 and FIG. 6, the split side doors 60 and 70 can be opened and a ramp 75 positioned to facilitate movement of waste materials, such as by walking or using a wheelbarrow, into the larger alternate configuration of the rear compartment 115.

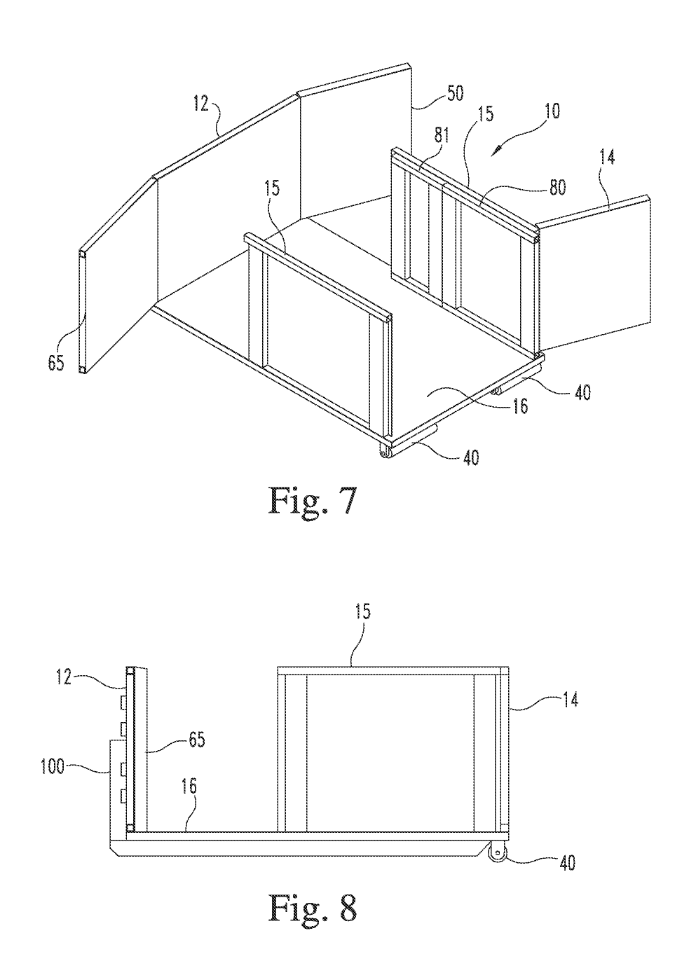

It should be evident that the specific size and shape of each door can be modified to achieve the intent of this device. Referring to FIG. 7 and FIG. 8, therein illustrated is another embodiment of the compartmentalized container where front right side-door 50 and front left side-door 65 are shown rotatably attached, such as by a hinge, to the front wall 12 of the container 10 and in open positions. Also shown in FIG. 7 the rear door 14 is shown in an open position and rotatably attached, such as by a hinge, to the side wall 15 of the container 10. The configuration of FIG. 7 also shows the internal divider wall main section 80 and base section 81 rotated flat against the side wall 15 so that the container 10 has a single internal compartment. This configuration with a single internal compartment may be desired toward the end of a construction project when all new materials are expended and maximum space is needed for discarded waste. The back door 14 can be fully opened and attached, such as by a chain or other latching mechanism, to the outside of the side wall 15 so that the back door 14 does not swing freely, for instance, when the container 10 is on a transport truck 200 and the back door 14 is opened so that waste material in the container 10 can be dumped out by tilting the container.

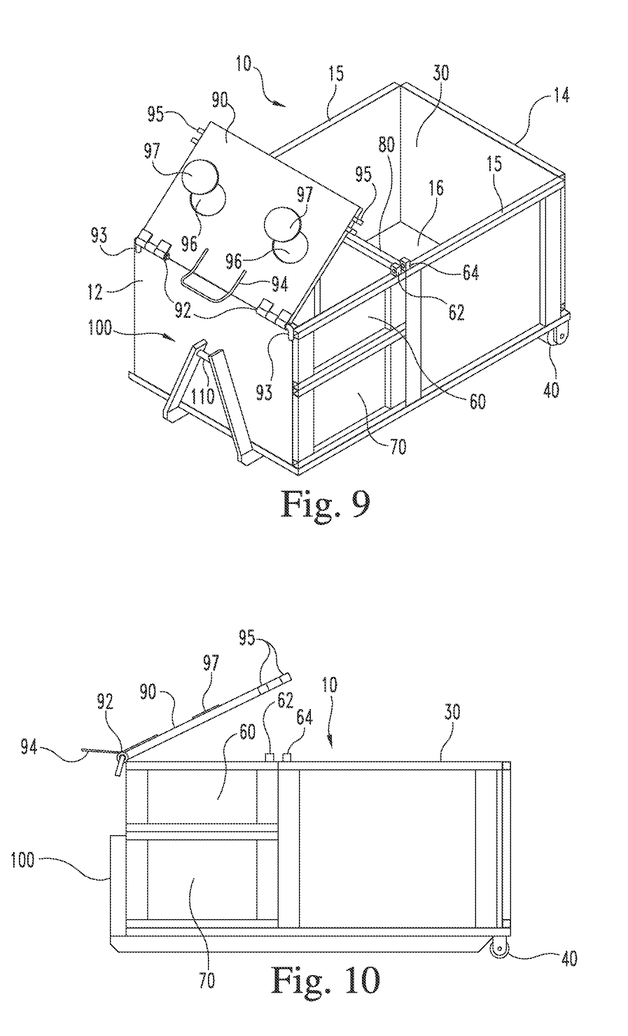

In FIG. 9 and FIG. 10, the compartmentalized container 10 is shown with a hinged removable top cover 90. The top cover 90 is shown to cover the front compartment 20 so that new construction materials can be loaded, delivered and stored in the front compartment 20 while being kept from exposure to the weather as well as being secured from theft.

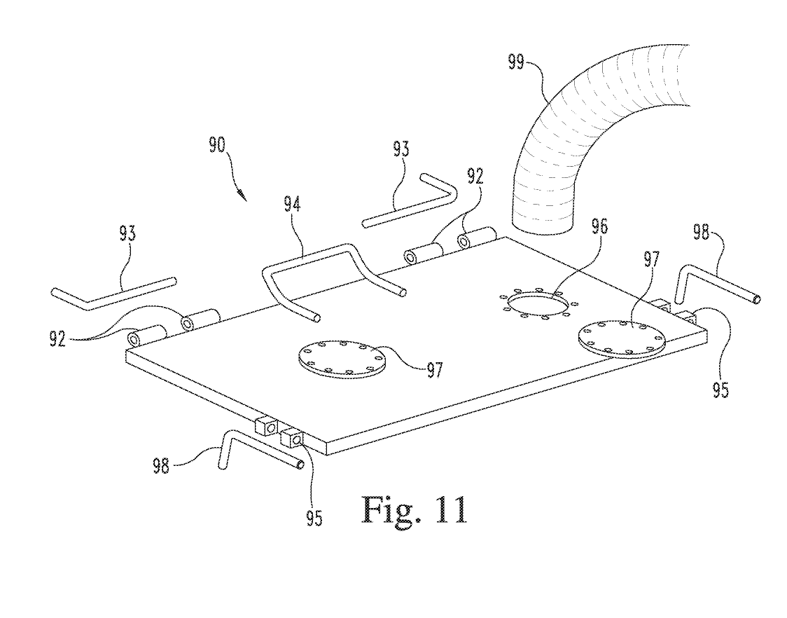

Referring now to FIG. 11, the details of the top cover 90 with various features will be explained. Top cover hinges 92 are located along one edge of the top cover 90 where the top cover will be rotatably attached to a wall of the container. In FIG. 9, FIG. 10 and FIG. 11, the top cover hinges 92 are configured so that the top cover 90 is rotatably attached to the front wall 12 of the container 10. Top cover hinge pins 93 or the like can be inserted through the top cover hinges 92 with mating hinges located on the front wall 12. The top cover hinge pins 93 are removable so that the top cover 90 can be removed. The top cover hinge pins 93 may also have a means of being locked, such as with a keyed lock, so that they can only be removed with a key. Locking hinge pins facilitate security when it is desired to lock the covered compartment.

Referring again to FIG. 11, additional features of the top cover 90 include a handle stop 94 that allows the top cover 90 to be held in an open position without swinging down fully against the outside of the front wall 12. When the top cover 90 is opened, the handle stop 94 comes in contact with the outside of the front wall 12 and holds the top cover 90 in a slightly forward leaning open position.

FIG. 11 also shows cover locking tabs 95 and locking pins 98. These tabs align with the door top locking tabs 62 and the wall top locking tabs 64 shown in FIG. 9 and FIG. 10 when the top cover 90 is in a closed position. The locking pins 98 are inserted through the locking tabs 62, 64 and 95 to lock the top cover 90 in a closed position. The locking pins 98 may be simple removable pins, or alternately may have a means of being locked, such as with a keyed lock, so that they can only be removed with a key. In combination with typical latches that may be used to lock the container side doors and divider wall, this ability to lock the closed compartment provides security against theft of materials on a job site.

Also shown are vent ports 96 with vent port covers 97. The vent ports 96 allow conditioned air, such as heated or cooled air, to be blown into the covered compartment of the container 10 such as by removing the vent port covers 97 and attaching a conditioned air injection tube 99 and forcing in air originating from a heating or cooling unit. When the vent ports 96 are not in use, the vent port covers 97 would remain in place and may be attached by any typical means, such as with screws, clips, hinged attachment or the like.

Referring again to FIG. 9 and FIG. 10, while the top cover 90 is shown to cover the front compartment 20, it should be understood that multiple top covers can be employed to cover any of the compartments within the container and that individual top covers may be configured to cover any combination of the compartments within the container. Further, the top cover 90 can be made to connect to the container 10 by a variety of means.

In FIG. 12, a hook lift transport truck 200 is shown with the compartmentalized container 10 half-on/half-off of the bed of the truck. A hook lift mechanism 220 is connected to the hook lift attachment assembly 100 and rolls it off of the truck 200 along the truck bed rollers 240 and with the rollers 40 of the container 10 rolling along the ground. The container 10 could also be loaded and unloaded using a crane, or alternately could be delivered with integrated wheels or on a trailer that is left on-site with the container until ready for removal.

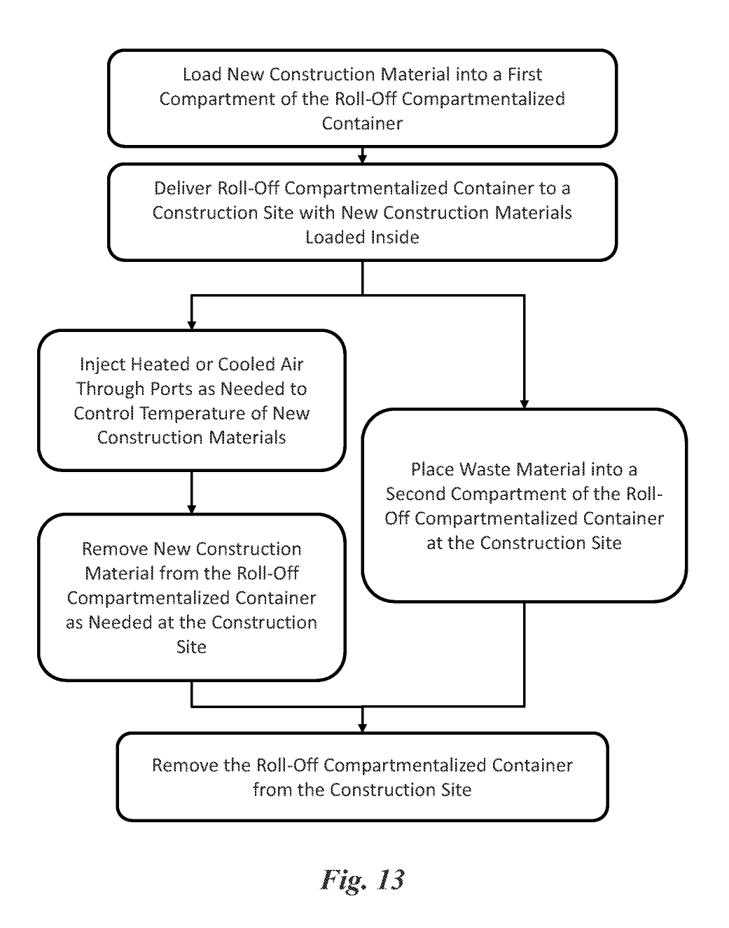

FIG. 13 illustrates the typical process for utilizing the compartmentalized container 10 on a construction site. In a first step, new materials may be loaded into a first compartment of the roll-off compartmentalized container 10. The roll-off compartmentalized container is then delivered to a construction site with the new construction materials loaded inside. On the job site, if the new construction materials require temperature conditioning, heated or cooled air is injected through the vent ports 96 as needed to control the temperature of the new construction materials. The new construction materials are removed from the container 10 as needed at the construction site. While new materials are being removed as needed, a second compartment of the compartmentalized container 10 is used to place waste material for disposal. When the container 10 is full of waste material or the construction job is completed, the container 10 is removed from the construction site.

While this version of the invention has been illustrated and described in detail in the drawings and foregoing description, the same is to be considered as illustrative and not restrictive in character, it being understood that only the preferred embodiments have been shown and described and that all changes and modifications that come within the spirit of the version of the invention are desired to be protected.

For instance, alternate versions of embodiments of the container can be provided with various dimensions, door configurations and compartment configurations. With respect to the above description then, it is to be realized that the optimum dimensional relationships for the parts of the invention, to include variations in sizes, lengths, diameters, materials, shape, form, function and manner of operation, assembly and use, are deemed readily apparent and obvious to one skilled in the art, and all equivalent relationships to those illustrated in the drawings and described in the specification are intended to be encompassed by the present invention.

From the foregoing, it will be understood by persons skilled in the art that an improved method of utilizing a compartmentalized container at construction sites, especially for roofing projects, has been provided.

Although this invention has been described in its preferred form with a certain degree of particularity, it is understood that the present disclosure of the preferred form has been made only by way of example and numerous changes in the details of construction and combination and arrangement of parts may be resorted to without departing from the spirit and scope of the invention.

What is claimed as the invention is:

1. A compartmentalized container for material management at a construction site, comprising:
a bottom plate having an upper surface, a lower surface, a front edge, a back edge and first and second side edges, where the bottom plate defines a container length from the front edge to the back edge, where the bottom plate defines a container width from the first side edge to the second side edge, and where the bottom plate is positioned above a staging surface;
a front wall having a forward external surface, an internal surface opposite the forward external surface, a top edge, a bottom edge, a left vertical side edge and a right vertical side edge, where the bottom edge of the front wall is attached to the front edge of the bottom plate;
a first and second side wall, where each side wall has an external surface, an internal surface, a top edge, a bottom edge, a forward vertical side edge and a rearward vertical side edge, where the first side wall is attached to the first side edge of the bottom plate, the second side wall is attached to the second side edge of the bottom plate and where the bottom plate, the front wall and the first and second side walls generally define a container having a container interior;
a back door and one or more side doors, where the back door has a back door hinged edge and a back door distal edge, where the back door hinged edge is rotatably attached to the rearward vertical edge of the first side wall and is rotatable in a horizontal plane, and where the side doors have side door hinged edges and side door distal edges, where the side door hinged edges are rotatably attached to a side vertical edge of said front wall and are rotatable in a horizontal plane;
an internal divider wall having a vertical attachment edge and a distal vertical edge, where the internal divider wall attachment edge is rotatably attached to the internal surface of the first side wall near the forward vertical side edge of first side wall and the distal vertical edge extends away from the attachment edge across the container interior and is rotatable between a first divider configuration, a second divider configuration and a third divider configuration, where in the first divider configuration the distal vertical edge of the internal divider wall extends across the container width to attach to the internal surface of the second side wall and divides the container interior into a front compartment and a rear compartment, where in the second divider configuration the distal vertical edge of the divider wall is rotated to attach to the internal surface of the front wall and divides the container interior into an alternate rear compartment and an alternate front compartment, and where in the third divider configuration the distal vertical edge of the divider wall is rotated so that the divider wall is parallel with and adjacent to the internal surface of the first side wall so that the container interior has a single compartment; and
a roller attached to the lower surface of the bottom plate near the back edge of the bottom plate.

2. The compartmentalized container for material management at a construction site according to claim 1, where the second side door is a split side door further comprised of a top split side door and a bottom split side door, where the top split side door and bottom split side door can be rotated separately between an open position and a closed position.

3. The compartmentalized container for material management at a construction site according to claim 1, further comprising a ramp having an upper surface, a lower surface, an upper edge, a lower edge and two side edges, where the upper edge of the ramp is attached proximate the side edge of the bottom plate and the lower edge extends in a downward slope away from the compartmentalized container where the lower edge rests on the staging surface.

4. The compartmentalized container for material management at a construction site according to claim 1, further comprising a hook lift attachment assembly attached proximate the forward external surface of the front wall where the hook lift attachment assembly includes a hook lift bar.

5. The compartmentalized container for material management at a construction site according to claim 1, further comprising:
a top cover, where the top cover has a cover upper surface, a cover lower surface, a cover hinged edge, a cover distal edge, and first and second cover side edges;
where the cover hinged edge is rotatably attached to the top edge of the front wall and is rotatable between an open position and a closed position; and
where the top cover covers the front compartment when the top cover is in the closed position.

6. The compartmentalized container for material management at a construction site according to claim 5, further comprised of:
wall top locking tabs attached at the top edge of first and second side walls proximate the forward vertical side edges;
door top locking tabs attached at the top edge of the side doors proximate the side door distal edge;
cover locking tabs attached at the cover side edges proximate the cover distal edge;
where the wall top locking tabs, the door top locking tabs and the cover locking tabs align when the top cover is in the closed position; and
where the wall top locking tabs, the door top locking tabs and the cover locking tabs have a means of being secured together so that the top cover distal edge is locked in place in the closed position.

7. The compartmentalized container for material management at a construction site according to claim 5, further comprised of:
vent ports, where the vent ports are holes in the top cover; and
vent port covers, where the vent port covers are removably attached to the vent ports.

8. A process of using a roll-off compartmentalized container for material management at a construction site, comprising the steps of:
a) providing a roll-off compartmentalized container comprising at least a first compartment and a second compartment;
b) loading new construction materials in said first compartment of said roll-off compartmentalized container;
c) providing a transport truck for transporting said roll-off compartmentalized container;
d) delivering said roll-off compartmentalized container to a construction site with said transport truck;
e) offloading the roll-off compartmentalized container from the transport truck at the construction site;
f) removing said new construction materials from said first compartment for use at said construction site;
g) placing construction waste material into said second compartment at said construction site;
h) on-loading the roll-off compartmentalized container on to the transport truck; and
i) removing said roll-off compartmentalized container from said construction site.

9. The process of using a roll-off compartmentalized container for material management at a construction site according to claim 8, where the roll-off compartmentalized container is further comprised of a top cover and vent ports.

10. The process of using a roll-off compartmentalized container for material management at a construction site according to claim 8, where the transport truck is a hook-lift truck.

11. A process of using a roll-off compartmentalized container for material management at a construction site, comprising the steps of:
a) providing a roll-off compartmentalized container comprising at least a first compartment, a second compartment, a top cover and vent ports;
b) loading new construction materials in said first compartment of said roll-off compartmentalized container;
c) providing a transport truck for transporting said roll-off compartmentalized container;
d) delivering said roll-off compartmentalized container to a construction site with said transport truck;
e) offloading the roll-off compartmentalized container from the transport truck at the construction site;
f) injecting conditioned air through the vent ports to heat or cool the new construction material;
g) removing said new construction materials from said first compartment for use at said construction site;
h) placing construction waste material into said second compartment at said construction site;
i) on-loading the roll-off compartmentalized container on to the transport truck; and
j) removing said roll-off compartmentalized container from said construction site.

12. The process of using a roll-off compartmentalized container for material management at a construction site according to claim 11, where the transport truck is a hook-lift truck.

13. The process of using a roll-off compartmentalized container for material management at a construction site according to claim 11, where the top cover covers the first compartment, where the top cover can be in an open position or a closed position, and where the top cover can be locked in the closed position.
